(19) United States
(12) Patent Application Publication
(10) Pub. No.: US 2017/0334035 A1
(43) Pub. Date: Nov. 23, 2017

(54) TOOL SPINDLE HAVING BALANCING SYSTEM, SYSTEM INCLUDING TOOL SPINDLE HAVING BALANCING SYSTEM, AND METHOD FOR OPERATING TOOL SPINDLE HAVING BALANCING SYSTEM

(71) Applicant: Klingelnberg AG, Zürich (CH)

(72) Inventor: Burkhard Scheider, Hückeswagen (DE)

(21) Appl. No.: 15/598,640

(22) Filed: May 18, 2017

(30) Foreign Application Priority Data
May 20, 2016 (DE) 102016006092.1

(51) Int. Cl. B24B 41/04; B23Q 11/00; B23F 23/12

(52) U.S. Cl. CPC B24B 41/042; B23F 23/1268; B23Q 11/0017

(57) ABSTRACT

A tool spindle having a spindle shaft rotationally-drivable about a spindle axis, a clamping system for the automatic chucking and unchucking of a tool, wherein the clamping system comprises a movement device enabling at least one movable and/or deformable clamping body of the clamping system to be transferred from a first position into a second position by execution of a movement of a part of the movement device in relation to the spindle shaft, wherein the tool is chucked on the tool spindle in the first position and the tool can be removed from the tool spindle in the second position, wherein it comprises a balancing system,
which is integrated into the tool spindle so that it rotates jointly with the rotationally-drivable spindle shaft,
which is arranged coaxially in relation to the spindle axis, and
which is mounted so it is axially movable.

This application claims priority under 35 U.S. C. §§119(a)-(d) to German patent application no. DE10 2016 006 092.1 filed May 20, 2016 which is hereby expressly incorporated by reference as part of the present disclosure.

### FIELD OF INVENTION

The invention relates to tool spindles having a balancing system, devices which comprise a tool spindle having a balancing system, and methods for operating a tool spindle having a balancing system.

### BACKGROUND

There are numerous processing methods for producing precision parts, in which the tool is chucked in a clamping device of a processing machine. During the chucking, it is important, on the one hand, that the tool is held sufficiently strongly in the clamping device that it is not disengaged or displaced in spite of the occurring processing forces. On the other hand, it is important to avoid the occurrence of an imbalance, because any tool imbalance results in reduced accuracy during the processing of the workpiece, on the one hand, and wear of parts of the processing machine, on the other hand.

An imbalance can occur within such a clamping system, for example, due to the displacement of a clamping claw. An imbalance system is known from document DE20215709U1, which comprises multiple weights, preferably in the form of balls, which are freely movable in a coaxial circumferential ring path. If an imbalance occurs due to the adjustment of the clamping system, these weights thus move automatically into a position within the ring path to thus compensate for this imbalance.

The chucking of a tool has to be performed so that it resists the processing forces absolutely without play, in the correct position, and secured in position.

The chucking can be time-consuming and work-intensive. A part of the required steps is frequently executed manually. Above all in the event of frequent tool change, such manual handling can be disadvantageous.

There has therefore been demand for some time to automate the chucking of tools. However, such automation has previously been opposed by the problem of balancing, unless one focuses on, for example, a robot operating at high precision, which is especially designed to automatically execute the individual manual handling steps. However, such robot-based approaches are costly and complex.

Balancing systems are partially used, which are to help in performing the chucking of the tool as much as possible without imbalance. Inter alia, there is the approach of attaching a balancing system to the receptacle body of the tool. In this case, each tool is equipped with a corresponding balancing system and tools are exchanged together with the balancing system during the tool change. This approach is costly and complex.

### SUMMARY

It is an object of some of the embodiments of the invention to find a way which enables a tool to be automatically clamped and/or disengaged and to perform an automated procedure for balancing after the chucking of a tool.

A corresponding achievement of the object is also to reduce the handling effort, which heretofore operating personnel have had to apply.

In at least some embodiments, the object is achieved by a tool spindle, a system that includes a tool spindle and/or a method for operating a tool spindle disclosed herein.

In accordance with a first aspect, a tool spindle is provided, which is provided with a spindle shaft, which is rotationally drivable about a spindle axis. The tool spindle comprises a chucking system for automatically chucking and unchucking a tool. The clamping system comprises a movement device, which enables at least one movable clamping body of the clamping system to be transferred from a first position into a second position by the execution of a movement of a part of the movement device in relation to the spindle shaft. In the first position, the tool is chucked on the tool spindle and in the second position the tool can be removed from the tool spindle. The tool spindle is distinguished in that it comprises a balancing system,
which is integrated into the tool spindle so that it rotates jointly with the rotationally-drivable spindle shaft,
which is arranged coaxially in relation to the spindle axis, and
which is mounted so it is axially movable.

The balancing system is integrated into the tool spindle in at least some embodiments so that the balancing system may be axially moved in relation to the spindle shaft, wherein the relative movement of the balancing system is induced by the movement device.

In at least some embodiments the balancing system is seated in a clamping sleeve or the balancing system comprises a housing which is designed as a clamping sleeve.

In at least some embodiments the balancing system comprises a jacket region, which is in a mechanical interaction with the at least one movable clamping body. This jacket region is located on a clamping sleeve or on a housing of the balancing system in at least some embodiments.

In at least some embodiments, the balancing system is integrated into a clamping system, and/or it is in a mechanical interaction with the clamping system, so that the chucking and/or disengagement of the tool occurs at the extreme end of the tool spindle, and the balancing system transmits the relative movement of the movement device required for the chucking and/or disengagement to the movable clamping body or bodies.

At least some embodiments of the invention may advantageously be used in machines which are equipped with a worm grinding wheel on the tool spindle. Because of the fact that such a worm grinding wheel does not have perfect rotational symmetry due to the worm shape extending in a spiral, the balancing plays a large role here. According to at least some embodiments of the invention, the balancing system is seated centrally in the inner region of the worm grinding wheel and it has a longitudinal extension in the axial direction which is approximately adapted to the longitudinal extension of the worm grinding wheel.

The balancing system is designed in at least some embodiments as an autonomous balancing system, which comprises at least one balancing sensor, a motor, and a balancing system controller.

The balancing system is supplied with energy by means of contactless transmission elements in at least some embodiments.

The balancing system can exchange signals with the machine and/or the machine with the balancing system in at least some embodiments. This unidirectional or bidirectional signal exchange can be performed by means of contactless transmission elements in at least some embodiments.

The balancing system is designed in at least some embodiments as a fully automatic balancing system, which recognizes imbalances early and remedies them to ensure a high quality in the workpiece processing and long service lives of the tool spindles.

It is a further advantage of at least some embodiments of the invention that the tool can be disengaged and replaced by another tool without problems.

### DRAWINGS

Exemplary embodiments of the invention will be described in greater detail hereafter with reference to the drawings.

FIG. 1A shows a perspective side view of a tool spindle having grinding tool, wherein the tool spindle is equipped with a balancing system according to at least some embodiments of the invention;

FIG. 1B shows a perspective side view of the tool spindle having balancing system of FIG. 1A, wherein some of the outer parts have been removed;

FIG. 1C shows a side view of the tool spindle having balancing system of FIG. 1B, wherein further parts have been removed;

FIG. 1D shows a side view of the front part of the tool spindle having balancing system of FIG. 1C, wherein essentially only the balancing system and a motor are still visible;

FIG. 1E shows a sectional view of the front part of the tool spindle having balancing system of FIG. 1D, wherein the balancing system can be seen in the interior of a clamping sleeve;

FIG. 2A shows a sectional view of the front part of the tool spindle having balancing system and tool according to at least some embodiments of the invention, wherein the tool can be removed from the tool spindle at the moment shown (designated second position);

FIG. 2B shows the sectional view of FIG. 2A, wherein the clamping body of the clamping system is shown in a closed position and the tool is fixedly connected to the tool spindle (designated first position);

FIG. 3A shows a perspective side view of a balancing system of at least some embodiments of the invention alone;

FIG. 3B shows a perspective side view of a further balancing system of at least some embodiments of the invention, which forms a functional unit together with a clamping sleeve;

FIG. 4 shows a very schematic view through the front part of a balancing system of at least some embodiments of the invention;

FIG. 5A shows a very schematic section through the front part of one half of a balancing system of at least some embodiments of the invention, which is constructed similarly as in FIG. 4, wherein the tool can be removed from the tool spindle in the position shown (designated second position);

FIG. 5B shows a very schematic section through the front part of the balancing system of FIG. 5A, wherein the tool is chucked in the position shown (designated first position).

### DETAILED DESCRIPTION OF EMBODIMENTS

Terms are used in conjunction with the present description which are also used in relevant publications and patents. However, it is to be noted that the use of these terms is only to serve for better comprehension. The inventive concepts are not to be limited by the specific selection of the terms. At least some embodiments of the invention may be readily transferred to other term systems and/or technical fields. The terms are to be applied accordingly in other technical fields.

Before some special embodiments are described, the essential terms are to be defined, insofar as they are not self-explanatory.

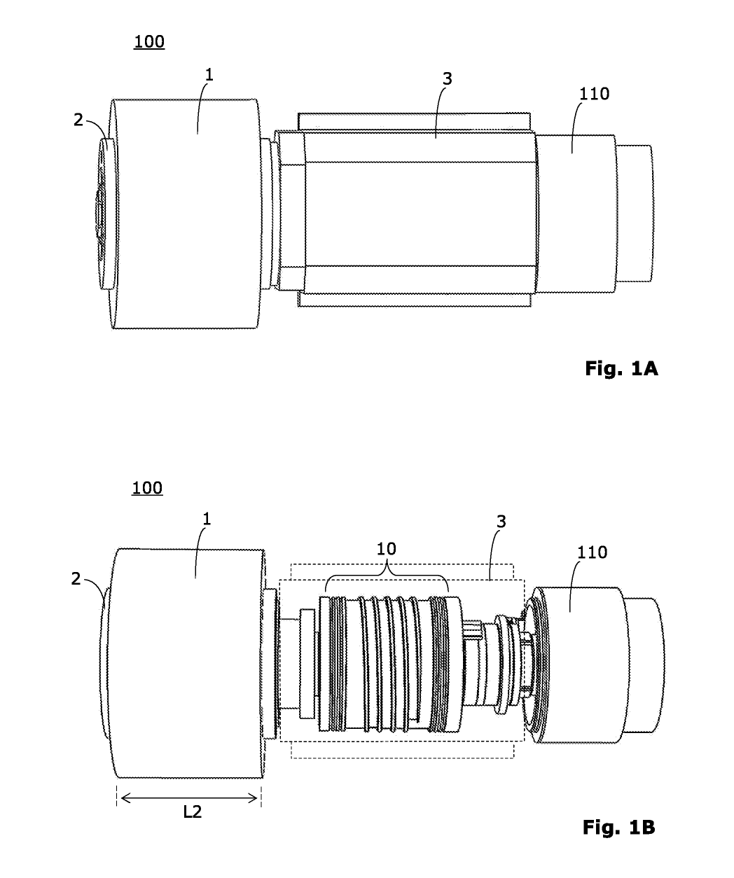

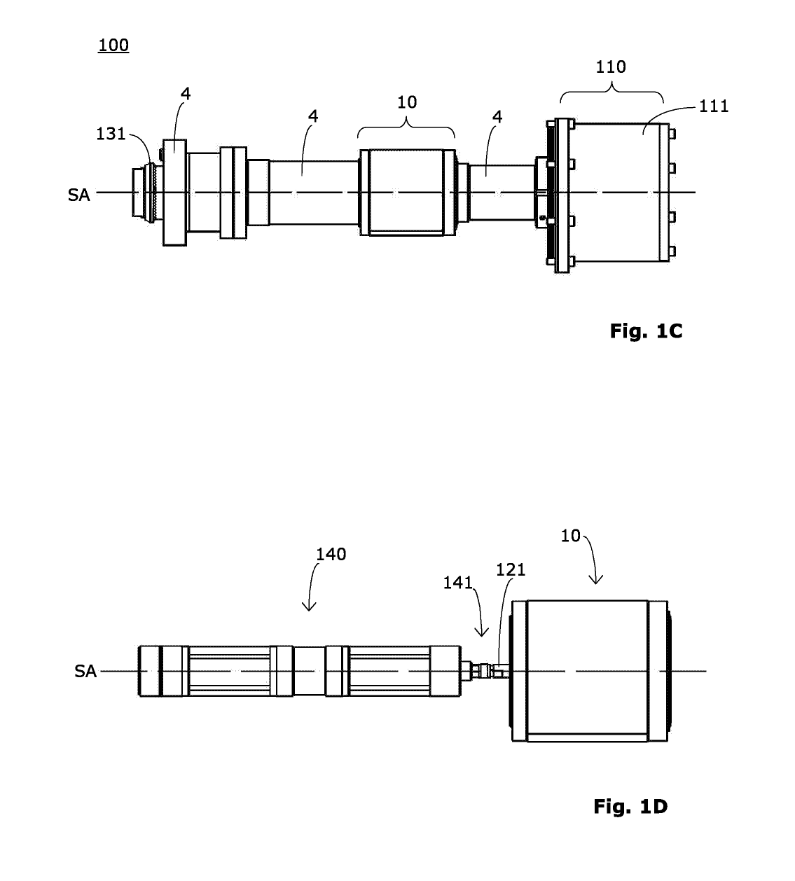

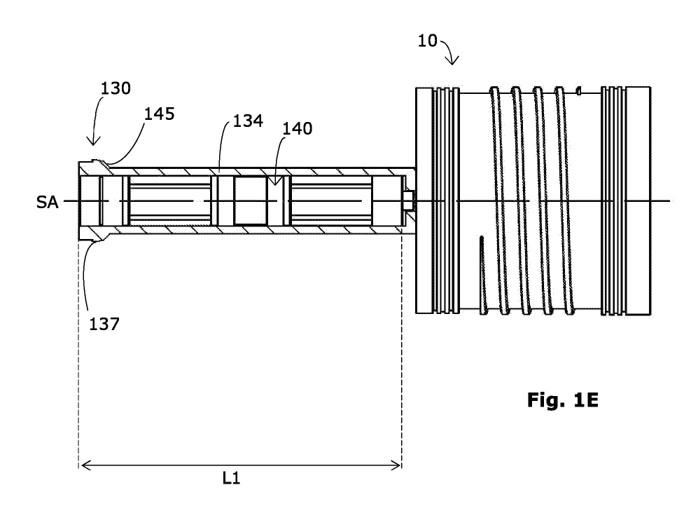

The tool spindle 100 of at least some embodiments comprises a clamping system 130 for automated chucking and unchucking of a tool 1. Various views of a first exemplary embodiment of the invention are shown in FIGS. 1A to 1E.

It can be seen in FIG. 1A that the tool spindle 100 (viewed from right to left) comprises a disengagement unit 110, a housing 3, a tool 1 (a stylized worm grinding wheel here) and a clamping flange 2.

The disengagement unit 110 is designed to be able to automatically chuck and unchuck (disengage) the tool 1. To be able to perform the chucking and disengagement, the disengagement unit 110 is (mechanically) connected to a movement device 120 of the clamping system 130. The reference sign 120 is not shown in the FIGS.. The reference sign 120 is merely to be understood as a summary of the various elements and components of the movement device.

The movement device 120 enables at least one movable clamping body 131 of the clamping system 130 to be transferred from a first position into a second position by way of the execution of a (linear) movement of a part of the movement device in relation to a rotationally-drivable spindle shaft 4 of the tool spindle 100. In the first position, the tool 1 is chucked on the tool spindle 100 and in the second position, the tool 1 can be removed from the tool spindle 100.

The tool spindle 100 is distinguished in that in at least some embodiments it comprises a balancing system 140,
which is integrated into the tool spindle 100 so that it rotates jointly with the rotationally-drivable spindle shaft 4, and
which is arranged coaxially in relation to the spindle axis SA.
In addition, the balancing system 140 is mounted so it is axially movable in the tool spindle 100.

It can be seen in FIG. 1B that the tool spindle 100 comprises a motor 10, which is seated in the interior of the housing 3. The outlines of the housing 3 are shown by dashed lines in FIG. 1B. This is, in at least some embodiments, an electric motor 10, which is used as the rotational drive of the tool spindle 100. A synchronous built-in motor is particularly suitable as the electric motor 10.

It can be seen in FIG. 1C that the spindle shaft 4 penetrates the tool spindle 100 nearly completely from the right end up to the left end (also designated the extreme end). The motor 10 encloses the spindle shaft 4, as shown in FIG. 1C. Details of an exemplary housing 111 of the disengagement unit 110 can be seen at the right end of the tool spindle 100. The clamping system 130, of which only the clamping body 131 can be seen on the left in FIG. 1C, is located at the extreme end.

FIG. 1D shows the balancing system 140. The balancing system 140 has a shape which is substantially cylindrical in the embodiment, which is to be understood as an example. A connecting device 141 is shown on the right, which is used as a mechanical connection to a pull rod or push rod 121. This pull rod or push rod 121 is part of the above-mentioned movement device 120.

In at least some embodiments, the clamping sleeve 134 can form a component together with the connecting device 141. In this case, the pull rod or push rod 121 is directly connected to the unit made of clamping sleeve 134 and connecting device 141.

In the embodiment shown in FIGS. 1A to 1E, the movement device 120 comprises a pull rod 121. Instead of a pull rod 121, a push rod or, for example, a (rotating) shaft can also be used. It is important that the movement device 120 comprises a part which can execute a relative movement in relation to the spindle shaft 4. This relative movement can be a pulling movement and/or a pushing movement and/or a rotational movement.

This relative movement acts on at least one movable clamping body 131 of the clamping system 130, to transfer it from the first position into the second position.

It can be seen in FIG. 1E that the balancing system 140 is seated in the interior of a (clamping) sleeve 134 of the clamping system 130. For example, a ramp 145 in the form of a circumferential edge is defined at the left end of the (clamping) sleeve 134. The function of this ramp 145 will be described later in conjunction with a further embodiment.

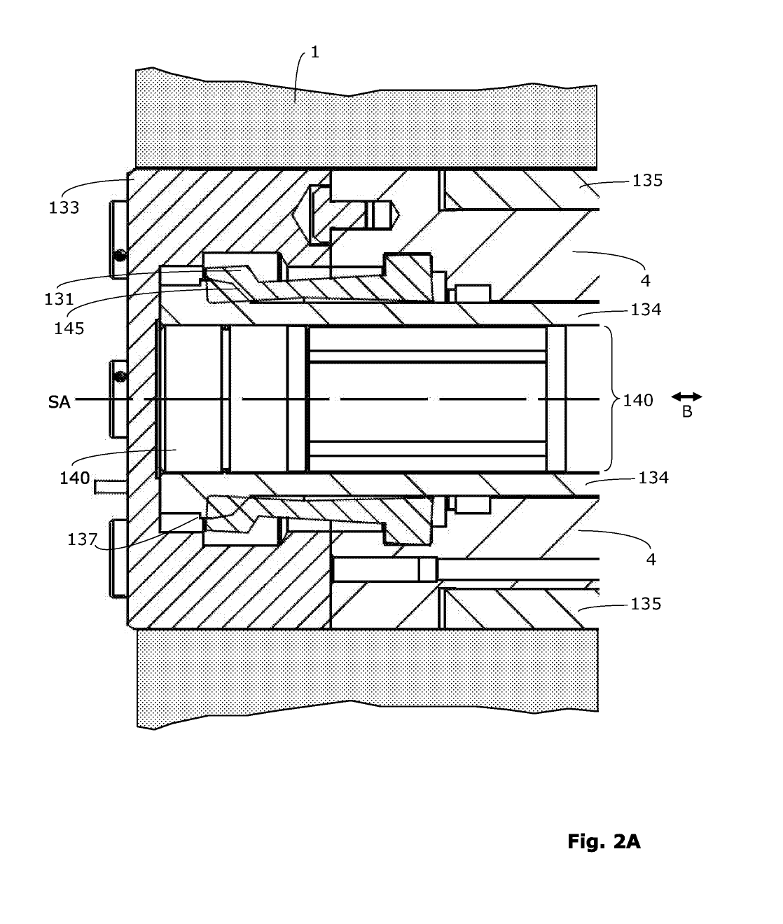

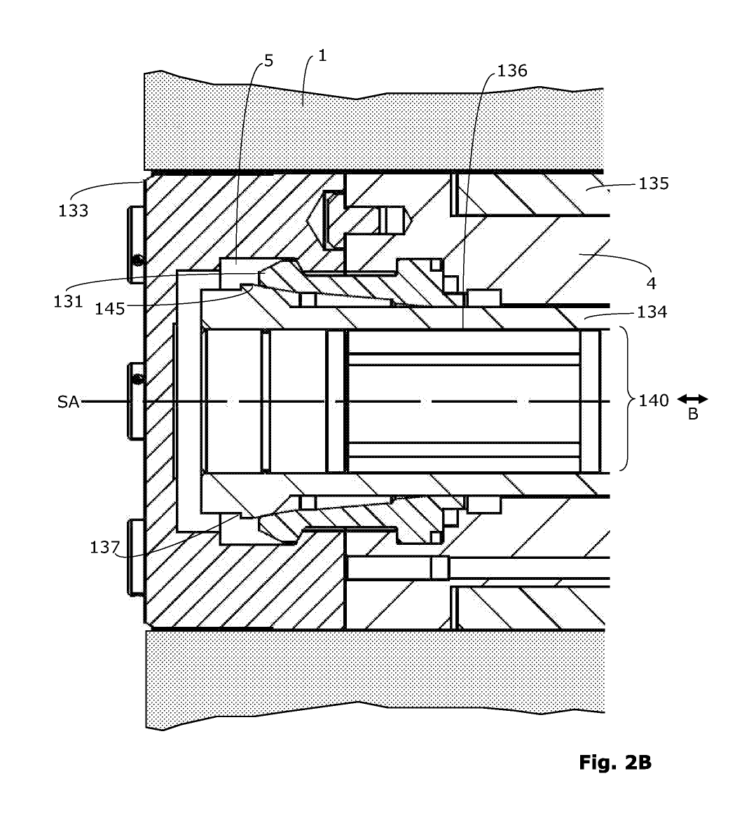

The front region of the tool spindle 100 of a further embodiment is shown in section in FIG. 2A. The clamping system 130 or the balancing system 140 also has a clamping sleeve 134 in this embodiment, as can be seen in FIGS. 2A and 2B. The clamping sleeve 134 has an inner receptacle opening 136 (see FIG. 2B), which has an inner shape which is formed as substantially complementary to the outer shape of the balancing system 140. In the embodiment shown, the balancing system 140 is seated in the receptacle opening 136 of the clamping sleeve 134.

In FIG. 2A, a double arrow B is shown on the right adjacent to the front region of the tool spindle 100. This double arrow B indicates that in this embodiment a pull rod 121 (as shown by way of example in FIG. 1D) can be moved to the right and left in parallel to the spindle axis SA. The double arrow B therefore designates the above-mentioned relative movement.

The clamping sleeve 134 having the internal balancing system 140 is seated in the interior of an end region of the spindle shaft 4. The clamping sleeve 134 including balancing system 140 can be moved to the right and left in relation to the spindle shaft 4. The corresponding movement is transmitted in the embodiment shown from the pull rod 121 via the connecting device 141 (as shown by way of example in FIG. 1D) to the clamping sleeve 134.

A clamping body 131, which is mounted so it is movable or which is deformable per se, is seated at the extreme end of the clamping sleeve 134.

In at least some embodiments, a clamping body 131 is used which is designed as a collet chuck. The clamping body 131 can comprise one collet chuck or multiple collet chucks in at least some embodiments.

The clamping body 131 is shown in the second position in FIG. 2A. In this exemplary embodiment, the tool 1 can be removed from the tool spindle 100.

Furthermore, it can be seen in FIG. 2A that the tool spindle 100 can comprise a main receptacle 133, for example, which directly or indirectly carries the tool 1. Such a main receptacle 133 can be used in at least some embodiments, wherein the shape thereof is dependent on the structural form of the tool 1.

A bearing flange 135 is used in the example shown, which partially protrudes into the interior of the main receptacle 133. Spindle bearings can be seated in the interior of the bearing flange 135, so that the spindle shaft 4 can rotate in relation to the bearing flange 135 about the spindle axis SA. This aspect of the spindle mounting is also to be understood as an example of this embodiment shown by way of example.

FIG. 2B shows the clamping system 130 in the first position and the clamping body 131 engages in a ring-shaped recess 5 of the main receptacle 133. If no main receptacle 133 is used, the ring-shaped recess 5 can also be provided directly on the interior of the workpiece 1. In this first position, the main receptacle 133 including the tool 1 may no longer be removed from the tool spindle 100.

In the first position, the tool 1 is fixedly chucked. The clamping body 131 engages in the ring-shaped recess 5 of the main receptacle 133 or the tool 1 to clamp the tool 1. The movement of the clamping body 131 from the second position into the first position can be implemented in at least some embodiments, for example, by a small linear movement of the clamping sleeve 134 including balancing system 140 to the right. Due to this small linear movement to the right, the clamping body 131 is pressed radially outward into the ring-shaped recess 5 at the above-mentioned ramp 145.

This specific embodiment of the clamping system 130 is to be understood as an example. There are also other clamping systems 130 which can be used in conjunction with at least some embodiments of the invention. It is important that a movable clamping body 131 of the clamping system 130 can be transferred from a first position into a second position, and this transfer is performed by the action of the movement device 120 (for example, by means of a pull rod and/or push rod and/or shaft).

In the above-described movement device 120, the clamping and the disengagement are implemented by a relative movement of a part of the movement device 120 in relation to the shaft 4.

However, embodiments are also known in which only the disengagement is implemented by a relative movement of a part (for example, by the linear movement of a pull rod or push rod 121) of the movement device 120 in relation to the shaft 4. In this case, before the removal of the tool 1 from the tool spindle 100, the clamping sleeve 134 including balancing system 140 is displaced to the left and the clamping body 131 passes into a position in which it presses closely against the outer circumference of the clamping sleeve 134. This state is shown in FIG. 2A.

In the embodiments in which only the disengagement is implemented by a relative movement of a part of the movement device 120 in relation to the shaft 4, the chucking of the tool 1 can be performed, for example, by means of a spring column, which is in the interior of the tool spindle 100. This spring column is arranged concentrically in relation to the spindle axis SA in at least some embodiment so that it draws (pre-tensions) the clamping sleeve 134 including balancing system 140 to the right. In this pre-tensioned position, which is also designated the main position, the tool 1 is fixedly connected to the tool spindle 100. It is the advantage of such spring-pre-tensioned embodiments that a force (for example, for linearly moving a pull rod or push rod 121) only has to be applied by the disengagement unit 110 to for the disengagement.

In at least some embodiments, the balancing system 140 is integrated into the tool spindle 100 so that the balancing system 140 may be moved axially (i.e., parallel to the spindle axis SA) in relation to the spindle shaft 4, wherein the relative movement of the balancing system 140 is induced by the movement device 120 (for example, only by a pull rod or push rod 121 or by a combination of a pull rod or push rod 121 with a spring column).

In at least some embodiments, the balancing system 140 is integrated into the tool spindle 100 so that it interacts with the movable or deformable clamping body 131 of the clamping system 130. The movement device 120 generates a relative (in at least some embodiments axially oriented) movement of the balancing system 140 in relation to the spindle shaft 4 by way of its relative (in at least some embodiments axially oriented) movement in relation of the spindle shaft 4. The relative (in at least some embodiments axially oriented) movement of the balancing system 140 is converted by the mentioned interaction into a (in at least some embodiments radially oriented) movement and/or a radially oriented deformation of the clamping body 131.

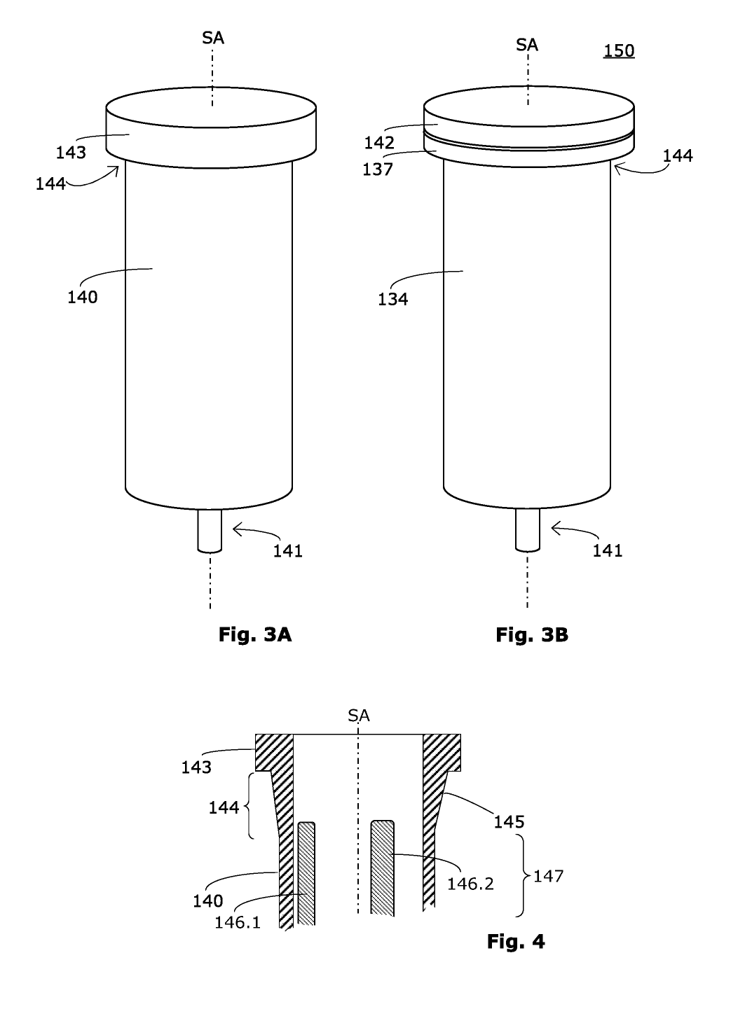

In at least some embodiments, the balancing system 140 is seated in a clamping sleeve 134 (as schematically indicated in FIG. 3B) or the balancing system 140 comprises a housing which is designed as a clamping sleeve (as schematically indicated in FIG. 3A). In the embodiment according to FIG. 3B, the balancing system 140 forms a functional unit 150 together with the clamping sleeve 134. Only a flange 142 of the balancing system 140 can be seen in FIG. 3B, because the remainder of the balancing system 140 is seated in the above-mentioned receptacle opening 136 of the clamping sleeve 134. A circumferential collar 137 of the clamping sleeve 134 can be seated directly below the flange 142. In the embodiment according to FIG. 3A, the flange 142 and the circumferential collar 137 are combined to form a circumferential collar 143.

Such a circumferential collar 137 or 143 can be used in at least some embodiments to define a ramp 145. Examples are shown in FIGS. 1E, 2A, 2B, 4, 5A, and 5B.

The position of the connecting device 141 is schematically indicated in each of FIGS. 3A and 3B by a cylindrical pin.

In at least some embodiments, the balancing system 140 comprises a jacket region 144, which is in a mechanical interaction with the at least one movable clamping body 131. This jacket region 144 is located in at least some embodiments on a clamping sleeve 134 (as shown in FIG. 3A) or on a housing of the balancing system 140 (as shown in FIG. 3B).

In at least some embodiments, the balancing system 140 comprises a jacket region 144, which forms a ramp 145 in the direction toward the circumferential collar 137 (in embodiments according to FIG. 3B) or in the direction toward the circumferential collar 143 (in embodiments according to FIG. 3A). The ramp 145 can be formed, for example, in that the external diameter of the housing of the balancing system 140 or the clamping sleeve 134 expands in the direction of the circumferential collar 137 or 143, respectively. The ramp 145 can be seen, for example, in FIGS. 1E, 2A, 2B.

In at least some embodiments, a truncated-cone-shaped jacket region 144 is used as the ramp 145.

FIG. 4 shows the extreme region of an embodiment according to FIG. 3A in section in schematic form. It can be seen in FIG. 4 that a cylindrical portion 147 of the balancing system 140 merges into the truncated-cone-shaped jacket region 144. In the example shown, the circumferential collar 143 follows immediately after the truncated-cone-shaped jacket region 144. The truncated-cone-shaped jacket region 144 forms the above-mentioned ramp 145.

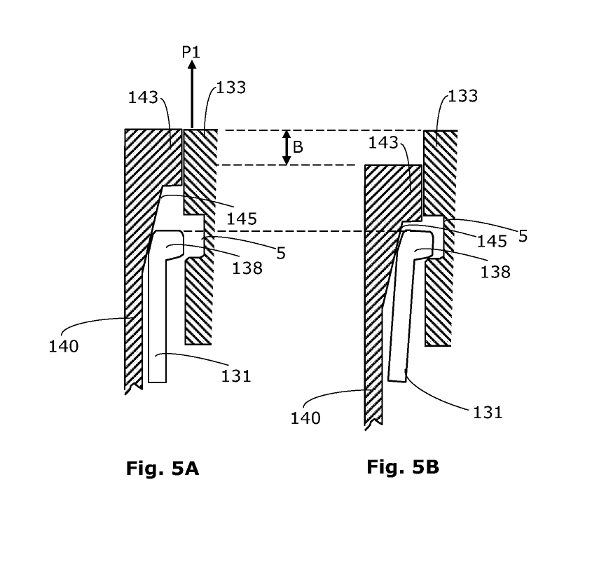

The mechanical interaction between the truncated-cone-shaped jacket region 144 and a clamping body 131 will now be explained on the basis of the two schematic sectional illustrations of FIGS. 5A and 5B. FIG. 5A shows the state of the clamping system 130 in the second position. FIG. 5B shows the state of the clamping system 130 in the first position. The transition from the second position to the first position can be achieved, for example, in that the balancing system 140 is linearly displaced in parallel to the spindle axis SA, which can be implemented, for example, by a spring column, as mentioned. The corresponding movement B is indicated in the region between FIGS. 5A and 5B by a double arrow. It can be seen on the basis of the comparison of the two FIGS. that the clamping body 131 slides upward due to the downward movement of the balancing system 140 in relation to the ramp 145. Because the diameter increases in the region of the ramp 145, the clamping body 131 is simultaneously displaced radially outward (for example, pivoted and/or deformed about a virtual pivot axis). During this movement outward, a head 138 of the clamping body 131 engages in the recess 5. This recess 5 can be provided, for example, on a main receptacle 133 or also on the tool 1, as already mentioned.

The recess 5 can be provided in at least some embodiments as a ring-shaped groove of the main receptacle 133 or the tool 1. However, there can also be one or more recesses 5, which has/have an extension of less than 360° in the circumferential direction.

The arrow P1 in FIG. 5A indicates that the tool 1 (not shown here) including the main receptacle 133 can be moved in the second position in a direction parallel to the spindle axis SA and removed (disengaged from the tool spindle 100).

In at least some embodiments, the balancing system 140 comprises at least one weight which is mounted so it is pivotable about the spindle axis SA. Two weights 146.1 and 146.2 are schematically shown in section in FIG. 4, wherein the first weight 146.1 is seated further outward viewed radially and has a smaller mass than the second weight 146.2, which is seated further inward viewed radially.

An exemplary balancing system 140, which can be used here, can be inferred, for example, from document DE4222535 A1. However, it is to be noted that such a balancing system cannot be assumed 1:1. The reference to this published patent application is merely to show that the functionality of such a balancing system 140 is known.

However, the balancing system 140 of at least some embodiments is designed to compensate for the imbalance, for example, of a worm grinding wheel 1, which results due to the incomplete rotational symmetry of the worm grinding wheel 1.

It is therefore advantageous if the balancing system 140, viewed in the axial direction, has a longitudinal extension L1 (see FIG. 1E) which approximately corresponds to the longitudinal extension L2 of the worm grinding wheel 1, as indicated in FIG. 1B. However, this comparison of the longitudinal extensions L1 and L2 primarily relates to the effective active length of the balancing system 140, i.e., it relates to the region of the balancing system 140 which is equipped with weight(s) 146.1, 146.2 displaceable in a controlled manner.

The balancing capacity of the balancing system 140 of at least some embodiments is designed for the imbalance to be expected of the included components. The location of the imbalance is detected by one or more balance sensors. The weights 146.1, 146.2 are then positioned by rotation and it is ascertained on the basis of the balance sensors whether there is still an imbalance. This is carried out and refined until the desired balance quality is achieved.

An autonomous balancing system 140 is used in at least some embodiments. Such an autonomous balancing system 140 is particularly distinguished in that in addition to the weight(s) 146.1, 146.2, it comprises at least one balance sensor (for example, an acceleration sensor and/or an acoustic sensor), a motor, and a balancing system controller.

An autonomous, dynamically operating balancing system 140 in the form of an electromechanical balancing system is used in at least some embodiments, the weights 146.1, 146.2 of which are electromechanically adjustable. Such a balancing system 140, which is autonomous and operates dynamically, enables the fully automatic balancing each case after the chucking of another tool 1.

In at least some embodiments, an autonomous balancing system 140 having contactless energy transmission is used, to be able to supply the motor and the balancing system controller from the machine. The transmitter for the contactless energy transmission is seated stationary in the region of the machine (where the tool spindle 100 is mounted on the machine) and the receiver is seated at the end of the rotating spindle shaft 4.

In accordance with at least some embodiments, an overall system comprises the above-described tool spindle 100 including a balancing system controller, which is designed to displace at least one weight 146.1, 146.2 of the balancing system 140 by way of a rotational movement, to reduce or compensate for an imbalance of the tool spindle 100 during the rotation about the spindle axis SA.

In at least some embodiments, the balancing system controller can have a signal connection to the balancing system 140 (in at least some embodiments contactless), to be able to displace the weight or the weights 146.1, 146.2 by way of a rotational movement via a motor of the balancing system 140.

In the described technical environment, the following method for operating the tool spindle 100 can be carried out. The following steps are executed during the chucking of a tool 1:
Executing a relative movement of the part 121 of the movement device 120 in relation to the spindle shaft 4, to transfer the movable clamping body 131 of the clamping system 130 from the first position into the second position. In the second position, the tool 1, possibly together with a main receptacle 133, can be placed on the tool spindle 100.
Executing a relative movement of the part 121 of the movement device 120 in relation to the spindle shaft 4, to transfer the movable clamping body 131 of the clamping system 130 from the second position into the first position. At this moment, the tool 1 is fastened on the tool spindle 100.

After the chucking of the tool 1, the following steps are then carried out automatically:
a) executing a rotational movement of the tool spindle 100 including tool 1 about the spindle axis SA (driven by the motor 10),
b) checking (for example, by means of a balance sensor) whether an imbalance exists,
c) rotationally displacing at least one balance 146.1, 146.2 of the balancing system 140,
d) repeating steps b) and c), until an imbalance no longer exists or until the imbalance is below a critical value.

As may be recognized by those of ordinary skill in the pertinent art based on the teachings herein, numerous changes and modifications may be made to the above described and other embodiments of the present invention without departing from the spirit of the invention as defined in the claims. Accordingly, this detailed description of embodiments is to be taken in an illustrative, as opposed to a limiting sense.

What is claimed is:

1. A tool spindle comprising:
a spindle shaft rotationally-drivable about a spindle axis,
a clamping system configured to automatically chuck and unchuck a tool, wherein the clamping system comprises at least one clamping body that is one or more of movable or deformable, and a movement device configured to transfer the clamping body from a first position into a second position by moving a part of the movement device relative to the spindle shaft, wherein a tool is chuckable on the tool spindle in the first position and removable from the tool spindle in the second position, and
a balancing system:
integrated into the tool spindle so as to rotate jointly with the spindle shaft,
arranged coaxially in relation to the spindle axis, and
mounted so as to be axially movable,
wherein the balancing system comprises:
at least one weight pivotally mounted about the spindle axis, and
a motor integrated into the balancing system and configured to pivot the at least one weight about the spindle axis.

2. The tool spindle according to claim 1, wherein the balancing system is configured as an autonomous balancing system and further comprises at least one balance sensor and a balancing system controller.

3. The tool spindle according to claim 1, wherein the at least one weight includes at least one weight that is displaceable in a controlled manner.

4. The tool spindle according to claim 1, wherein the balancing system comprises one or more balance sensors to sense a location of imbalance.

5. The tool spindle according to claim 4, wherein the at least one weight is rotationally positionable.

6. The tool spindle according to claim 1, wherein the balancing system is mounted so as to be axially movable with the movement of the part of the movement device.

7. The tool spindle according to claim 1, wherein the balancing system has a jacket region that mechanically interacts with the at least one clamping body.

8. The tool spindle according to claim 1, wherein the spindle shaft comprises a coaxial receptacle opening at an extreme end thereof, and the balancing system is seated in an interior of the receptacle opening.

9. The tool spindle according to claim 1, further configured to transfer the at least one clamping body from the second position into the first position by movement of said part of the movement device relative to the spindle, wherein the at least one clamping body is configured to be displaced outwardly in a radial direction during the movement of the part of the movement device relative to the spindle shaft during transfer from the second position to the first position to thereby engage in a recess of a tool.

10. The tool spindle according to claim 1, further comprising a main receptacle defining a recess and configured to carry a tool, wherein the tool spindle is further configured to transfer the at least one clamping body from the second position into the first position by movement of said part of the movement device relative to the spindle, and wherein the at least one clamping body is configured to be displaced outwardly in a radial direction during the movement of the part of the movement device relative to the spindle shaft during transfer from the second position to the first position to thereby engage in the recess of the main receptacle.

11. The tool spindle according to claim 1, wherein the balancing system defines an indentation and the at least one clamping body is movable and configured to be displaced inwardly in a radial direction during the movement of the part of the movement device relative to the spindle shaft during transfer from the first position to the second position to thereby retract into the indentation of the balancing system.

12. The tool spindle according to claim 1, wherein the clamping sleeve defines an indentation and the at least one clamping body is movable and configured to be displaced inwardly in a radial direction during the movement of the part of the movement device relative to the spindle shaft during transfer from the first position to the second position to thereby retract into the indentation of the clamping sleeve.

13. The tool spindle according to claim 1, wherein the part of the movement device
includes a push rod that extends axially relative to the spindle axis and is configured to transfer the at least one clamping body from the first position to the second position or from the second position to the first position by a pushing movement parallel to the spindle axis, or
is a pull rod that extends axially in relation to the spindle axis and is configured to transfer the at least one clamping body from the first position to the second position or from the second position to the first position by a pulling movement parallel to the spindle axis.

14. The tool spindle according to claim 1, wherein the movement device comprises a spring column configured to automatically transfer the at least one clamping body from the second position to the first position.

15. A system comprising:
a tool spindle comprising:
a spindle shaft rotationally-drivable about a spindle axis,
a clamping system configured to automatically chuck and unchuck a tool, wherein the clamping system comprises at least one clamping body that is one or more of movable or deformable, and a movement device configured to transfer the clamping body from a first position into a second position by moving a part of the movement device relative to the spindle shaft, wherein a tool is chuckable on the tool spindle in the first position and removable from the tool spindle in the second position, and
a balancing system:
integrated into the tool spindle so as to rotate jointly with the spindle shaft,
arranged coaxially in relation to the spindle axis, and
mounted so as to be axially movable,
wherein the balancing system comprises:
at least one weight pivotally mounted about the spindle axis, and
a motor integrated into the balancing system and configured to pivot the at least one weight about the spindle axis; and
a balancing system controller configured to control said pivoting of the at least one weight, to reduce or compensate for an imbalance of the tool spindle during rotation of the tool spindle about the spindle axis.

16. The system according to claim 15, wherein the balancing system controller is configured to exchange a signal to the balancing system by a signal connection thereto to control said pivoting of the at least one weight by the motor of the balancing system.

17. A method comprising:
operating a tool spindle that comprises
a spindle shaft rotationally-drivable about a spindle axis,
a clamping system configured to automatically chuck and unchuck a tool, wherein the clamping system comprises at least one clamping body that is one or more of movable or deformable, and a movement device configured to transfer the clamping body from a first position into a second position by moving a part of the movement device relative to the spindle shaft, wherein a tool is chuckable on the tool spindle in the first position and removable from the tool spindle in the second position, and
a balancing system:
integrated into the tool spindle so as to rotate jointly with the spindle shaft,
arranged coaxially in relation to the spindle axis, and
mounted so as to be axially movable,
wherein the balancing system comprises:
at least one weight pivotally mounted about the spindle axis, and
a motor integrated into the balancing system and configured to pivot the at least one weight about the spindle axis; and
wherein the at least one clamping body is movable,
wherein the operating step includes:
during chucking of a tool, moving the movement device relative the spindle shaft and, in turn, transferring the at least one clamping body from the second position to the first position, and
after said chucking of the tool:
a) executing a rotational movement of the tool spindle including the tool about the spindle axis,
b) determining whether an imbalance exists,
c) pivoting the at least one weight of the balancing system about the spindle axis if an imbalance exists, and
d) repeating steps b) and c) until an imbalance no longer exists or until the imbalance is below a predetermined value.
